(19) United States
(12) Patent Application Publication
(10) Pub. No.: US 2006/0209480 A1
(43) Pub. Date: Sep. 21, 2006

(54) Device and method for protecting an electric machine

(76) Inventors: Andreas Fritsch, Kummersbruck (DE); Thomas Heberlein, Feucht (DE); Manfred Prolss, Ebermannsdorf (DE)

Correspondence Address: HARNESS, DICKEY & PIERCE, P.L.C., P.O.BOX 8910, RESTON, VA, 20195, US

(21) Appl. No.: 10/563,958

(22) PCT Filed: May 5, 2004
(86) PCT No.: PCT/EP04/04783

§ 371 Date: Jan. 10, 2006

(30) Foreign Application Priority Data
Jul. 11, 2003 (EP) 03015895.0

(51) Int. Cl. H02H 3/00

(52) U.S. Cl. 361/79

(57) ABSTRACT

An aim of an embodiment of the invention is to better use the time forecast for switching off an overload protection device. For this purpose, the determination of a trigger-release time reserve is related to a corresponding evaluation. In such a manner, it is possible, for example to dynamically determine whether a desired process can be carried out in the total length thereof or automatically disjointed, thereby making it possible to generate corresponding warning signals.

This application is the national phase under 35 U.S.C. § 371 of PCT International Application No. PCT/EP2004/004783 which has an International filing date of May 5, 2004, which designated the United States of America and which claims priority on European Patent Application number EP 03015895.0 filed Jul. 11, 2003, the entire contents of which are hereby incorporated herein by reference.

### FIELD

The present invention generally relates to a protective apparatus for protecting an electric machine against current overload. The present invention further generally relates to a corresponding method for protecting an electric machine.

### BACKGROUND

Electric machines, in particular motors, can be operated temporarily with a current level above the rated or continuous current level. The reason for this is that overheating of the electric machine only occurs after a certain amount of time. The electric machines are therefore divided into certain τ classes (CLASS or disconnection class). In each case the permitted multiple of the rated current and the period of time for which the electric machine can be operated at this increased current without overheating occurring are defined in these classes.

Until now mechanical overload relays have typically been used for motor protection. These overload relays are capable, by way of a bimetallic strip, of interrupting the power supply in the event of a limit current being exceeded, the time up to the interruption being a function of the current. The bimetallic element used for this purpose has been simulated in terms of its thermal properties in electronic overload devices for some time by way of software/firmware. In this case, a thermal variable, namely the thermal motor model (TMM), is used in order to set a thermal motor model curve as a function of a present current. The thermal motor model TMM can be represented as follows:

$$TMM = [ 1 - {ⅇ}^{\frac{1}{τ}} ] \cdot \frac{{I}_{pres}}{{I}_{limit}}$$

Here, τ corresponds to the time from the τ classification, Iₚᵣₑₛ corresponds to the present current value, Iₗᵢₘᵢₜ corresponds to a predetermined current limit value and t corresponds to the time. An overload device is triggered if TMM=1=100%. Assuming constant currents, the respective triggering time can thus be calculated if the machine is restarted, i.e. at TMM=0.

Since this calculation in the firmware is complex owing to the need for precise time stamping, the function is simulated using the following recursive time formulation:

$${TMM}_{n + 1} = {TMM}_{n} - \frac{{TMM}_{n}}{\frac{τ}{Δ t}} + \frac{{I}_{pres}}{\frac{τ}{Δ t}}$$

The function values are calculated in the time frame Δt, and the respective value TMMₙ₊₁ is monitored with respect to a current-dependent disconnection threshold, a predetermined value.

With this implementation it is possible to realize a trigger for the overload function. In this case, triggering can be carried out by way of a disconnection command or direct current interruption.

A message/warning as to whether triggering will take place by the overload device is likewise possible with this technology. For this purpose, a test is carried out to establish whether the present current is greater than a predetermined limit current. In this case, a large, temporal, thermal reserve of the motor remains unconsidered in certain circumstances. A prediction as to when triggering of the overload device will probably take place has until now been made as follows: A PLC reads the present value of the TMM and the present current from the electronic overload device in order to then make a prediction using the constants given. A necessary precondition is therefore that the overload device is capable of communication.

One further disadvantage when making the prediction is the fact that the present operating state of the overload relay (CLASS, imbalance, present current value, present limit value, . . . ) needs to be simulated. The prediction is therefore associated with a very high degree of complexity and can therefore not be carried out in real time. A further disadvantage thus results in that the user needs to simulate the model function in the user program of its controller. For this purpose, corresponding know-how is required and considerable cycle loads result.

EP 0 999 629 A1 has disclosed an apparatus for the thermal overload protection of an electric motor. In this apparatus, the supply currents to the motor are detected, and, associated with specific supply currents, times are defined at which the current is to be disconnected. In a thermodynamic model, state equations are used whose parameters are determined as a function of these times. A calculation is performed to ascertain whether predetermined threshold values have been exceeded or not.

U.S. Pat. No. 6,424,266 B1 describes a device for preventing thermal damage to an electric load transformer. The input current into the load transformer is detected and, on the basis of a prediction algorithm, which uses the current value and the present value for the ambient temperature, a time is calculated after which an output alarm contact is to be closed.

U.S. Pat. No. 4,467,260 has disclosed a motor starter controlled by a microprocessor. In this case, a curve is used, inter alia, in which the temperature of a rotor is exponentially dependent on the time.

### SUMMARY

An object of at least one embodiment of the present invention is to propose an apparatus and a method for protecting electric machines with which it is possible to predict a temporal trigger reserve without a high degree of complexity.

An object may be achieved by a protective apparatus for protecting an electric machine against current overload and/or a method for protecting an electric machine against current overload.

It is thus possible according to at least one embodiment of the invention to realize a temporal prediction, together with an evaluation of the dynamic, temporal trigger reserve of an electronic overload function, in a device with overload functionality.

The thermal motor model is calculated in the prediction device as the present thermal variable as a function of the present current value, of a current limit value and of a time which is characteristic of the electric machine, and the thermal motor model is used as the basis for the prediction. The thermal motor model TMM is preferably calculated recursively in the prediction device. The present thermal motor model is expediently used for dynamically calculating the time value for the prediction.

The prediction device and/or the utilization device can advantageously be parameterized. Any desired limit values and device properties can thus be prescribed and used in the prediction or utilization.

A disconnection signal or warning signal can be generated as a control signal in the utilization device. The prediction can thus be used to ensure that a desired control cycle with excessive current is not possible at all or that a warning is output when the control cycle is created or used to indicate that the control cycle has not completely run and a premature interruption has taken place.

It is therefore possible according to at least one embodiment of the invention for the calculation of the prediction of the temporal trigger reserve to be integrated in a device having an overload function. Owing to this integration, it is no longer necessary for the device having the overload function to be capable of communication.

In one specific embodiment, the temporal trigger reserve can be monitored by way of limit-value monitoring devices at a predictor limit value. The temporal trigger reserve and/or the result of the limit-value monitoring device can also be processed locally or passed, for processing, on to the controller (PLC). The predictor limit value and the subsequent response or passed on to the controller (PLC) for processing purposes. The predictor limit value and the subsequent response may be parameterized or set, as already indicated.

The user can advantageously use the combination according to at least one embodiment of the invention of prediction and evaluation for the purpose of maintaining his processes. Furthermore, it is possible, according to at least one embodiment of the invention, for the user to utilize the maximum temporal, thermal reserve of the motor for his processes without any loss in the motor protection function or any risk to his processes.

One further advantage resides in the fact that the presently valid parameters/constants/operating circumstances (CLASS, currents, imbalance with respect to the phases) are always used in the calculation in real time since the calculation takes place in the overload device. Accordingly, however, the prediction and evaluation can take place in devices which are not capable of communication, the link between the prediction and evaluation—as already mentioned—taking place by way of parameters and adjusting elements.

### BRIEF DESCRIPTION OF THE DRAWINGS

Embodiments of the present invention will be explained in more detail with reference to the attached drawings, in which:

FIG. 1 shows a block diagram of a motor protection device according to at least one embodiment of the invention;

FIG. 2 shows a current waveform graph; and

FIG. 3 shows a graph of the thermal variable TMM as a result of the current waveform shown in FIG. 2.

### DETAILED DESCRIPTION OF THE EXAMPLE EMBODIMENTS

The example embodiments described in more detail below represent preferred example embodiments of the present invention.

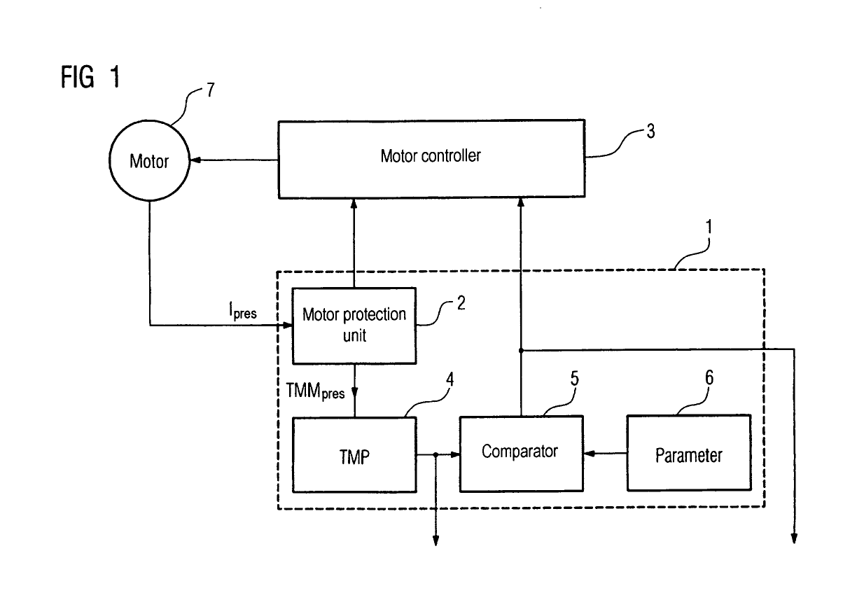

FIG. 1 illustrates, using a dashed line, a motor protection device 1. This motor protection device 1 has a motor protection unit 2 for current detection, current provision and TMM formation for the motor protection which obtains a present current value Iₚᵣₑₛ from a motor 7. In the event of overheating, the overload device 2 outputs a corresponding command to the motor controller 3 or directly interrupts the current supply to the driven motor.

The motor protection unit 2 provides a present thermal value TMMₚᵣₑₛ to a prediction unit (TMP) 4, which is likewise integrated in the motor protection device 1. The prediction unit 4 forms a temporal prediction value, namely a temporal trigger reserve, from the thermal value TMMₚᵣₑₛ, and provides this temporal prediction value to a comparator 5, which is connected to the prediction unit 4 and is likewise integrated in the motor protection device 1.

The comparator 5 can be parameterized via a parameterization unit 6 which is likewise integrated in the motor protection device 1. If possible, the motor protection unit 2 and the prediction unit 4 can also be parameterized via the parameterization unit 6. Corresponding connections are not illustrated in FIG. 1 for reasons of clarity.

It is established in the comparator 5 whether the temporal trigger reserve is greater or less than a parameterized limit value (predictor limit value). If the trigger reserve is less than the parameterized limit value (predictor limit value), a warning signal or control signal is output to the motor controller 3 such that either the user is warned that automatic shutdown is probably to be expected in the case of the desired driving, or driving of the motor with the desired drive curve will not be permitted.

The motor controller 3 may also be integrated in the motor protection device 1.

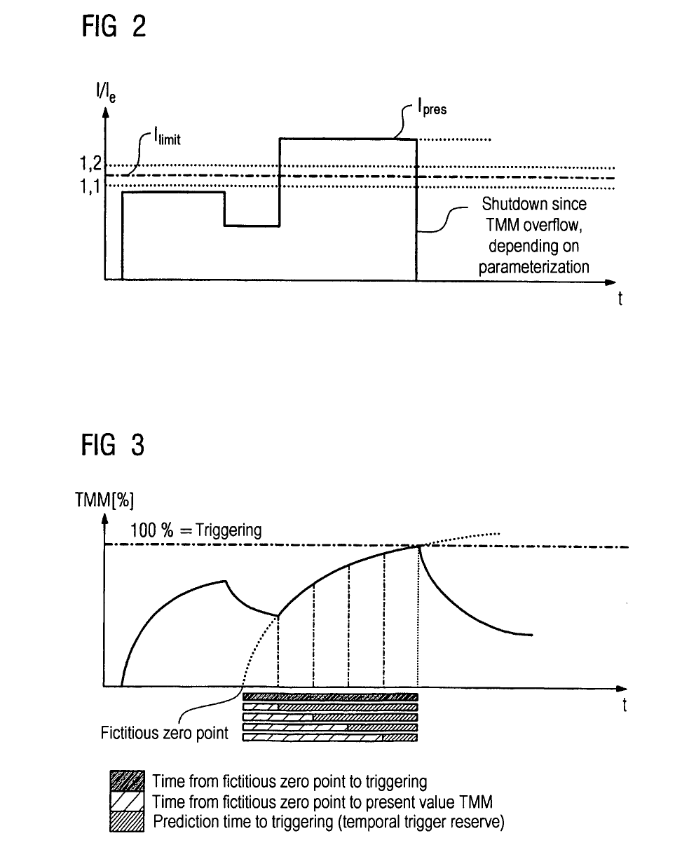

In the example selected in FIG. 2, the motor is initially operated with a current which is below a standardized limit current window. This limit current window is defined as 1.1 . . . 1.2×Iₑ. In this case, Iₑ corresponds to the set or rated current with which the motor can be operated continuously. After a certain amount of time, the current Iₚᵣₑₛ decreases (for example by means of a change in load) and then increases above the limit current window in which a limit current Iₗᵢₘᵢₜ to be defined lies. This high current would lead to the motor being overheated for a long period of time.

In FIG. 3, the thermal variable TMM is plotted which temporally corresponds to the current waveform shown in FIG. 2. The curve profile in the stepless sections is given by the exponential function described in the introduction to the description. Accordingly, the temperature of the motor increases in accordance with the mentioned exponential function once the motor has been switched on, but would not reach a specific trigger threshold, in this case 100%, since the current is below the limit current (cf. FIG. 2).

When the current is subsequently reduced, the temperature also decreases again. If the current is then increased to a value above the limit current Iₗᵢₘᵢₜ, the temperature increases continuously and reaches the trigger threshold TMM=100%. At this point, the current to the motor is disconnected (cf. FIG. 2) such that the temperature of the motor also gradually decreases again (cf. FIG. 3).

In order to drive the motor or to fix current drive profiles, it is necessary to know the temporal trigger reserve at which TMM reaches the threshold value 100%. It should thus be possible for a prediction to be made in real time of the temporal trigger reserve at any desired points in time. This should not only be based on the steady-state case in which the motor is continuously driven at a constant current, but also it should be possible for the dynamic variant to be considered if the current changes in the course of driving.

One possible calculation method for determining the trigger reserve is based, for example, on the fact that a fictitious zero point of the e function is calculated. This zero point defines the point in time at which TMM=0 whilst taking into consideration the present TMM and the present current Iₚᵣₑₛ. With knowledge of the limit current Iₗᵢₘᵢₜ, the τ class and the imbalance information with respect to the phases which are present at that point in time, it is possible for a dynamic prediction to be made of the time taken before triggering, i.e. before the motor is disconnected. At any point in time, a present temporal prediction can be made on the basis of the fictitious zero point, as is indicated in FIG. 3 at the bottom by horizontal bars. In this case, the present TMM value and the present current can be taken into account with each updating.

According to at least one embodiment of the invention, the temporal prediction of the trigger reserve is linked with a user function. For example, the dynamic temporal prediction of the trigger reserve of an electronic overload function can thus be linked with an overload message or warning. As has already been mentioned, the user can be warned prior to using a drive profile which will probably lead to automatic shutdown of the motor. This undesired shutdown may have very disadvantageous consequences in certain processes.

The individual parameters for determining the trigger reserve can in this case be input by the parameterization unit 6 (cf. FIG. 1) using a corresponding input interface. In addition, a correspondingly obtained, possibly standardized prediction value of the temporal trigger reserve can be made available to a programmable logic controller (PLC) or another system for further processing purposes.

One specific example embodiment of the present invention will be described below. Accordingly, a fan motor is necessarily required for cooling a production process, for example. Failure of the fan would lead to damage to the finish and would thus result in rejects.

In accordance with the previous prior art, no mention is made before starting the finishing process as to whether the cooling can be maintained throughout the finishing process. According to at least one embodiment of the invention, the user then paramaterizes the maximum process runtime as a predictor limit value. By appropriately adjusting the parameters, an instance of the required cooling time being undershot is defined as a process fault. Before the unmachined part is introduced into the finishing process, a check is carried out using the thermal memory predictor (TMP) and its limit-value monitoring device to establish whether the temporal thermal reserve is provided for the execution of the finishing process. It is thus possible for the motor and thus the entire process to be used in a more targeted manner. In particular, critical process sections can be safeguarded more effectively.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A protective apparatus for protecting an electric machine against current overload comprising:
a current value provision device for providing a present current value with which the electric machine is operated;
a prediction device for determining the thermal motor model TMM as a function of the present current value, a predetermined current limit value, and a time, predetermined by the classification of the electric machine, and for predicting an absolute or relative time value for a trigger reserve, in the case of which the thermal motor model reaches a value of one; and
a utilization device for utilizing the time value for the trigger reserve for generating a control signal.

2. The protective apparatus as claimed in claim 1, wherein, when providing a current Iₚᵣₑₛ from the point in time t=0 on, TMM is given by:
$$TMM = [ 1 - {ⅇ}^{\frac{1}{τ}} ] \cdot \frac{{I}_{pres}}{{I}_{limit}} ,$$
where Iₗᵢₘᵢₜ is the current limit value, and t is the predetermined time.

3. The protective apparatus as claimed in claim 1, wherein the thermal motor model is recursively calculatable in the prediction device.

4. protective apparatus as claimed in claim 1, wherein the time value is dynamically calculatable using the present value for the thermal motor model.

5. The protective apparatus as claimed in claim 1, wherein at least one of the prediction device and the utilization device is parameterizable.

6. The protective apparatus as claimed in claim 1, wherein at least one of a disconnection signal and a warning signal are generatale as a control signal in the utilization device.

7. A method for protecting an electric machine against current overload, the method comprising
provisioning a present current value with which the electric machine is operated;
determining a thermal motor model based on the present current value, a predetermined current limit value and a time predetermined by the classification of the electric machine;
predicting an absolute or relative time value for a temporal trigger reserve as a function of the thermal motor model in which the thermal motor model reaches a value of one;
generating a control signal using the time value; and
driving the electric machine using the control signal.

8. The method as claimed in claim 7, wherein, when providing the present current value Iₚᵣₑₛ from the point in time t=0 on, the thermal motor model is given by:
$$TMM = [ 1 - {ⅇ}^{\frac{1}{τ}} ] \cdot \frac{{I}_{pres}}{{I}_{limit}} ,$$
where Iₗᵢₘᵢₜ is the current limit value and t is the predetermined time.

9. The method as claimed in claim 7, wherein the thermal motor model is calculated recursively.

10. The method as claimed in claim 7, wherein the time value is calculated dynamically using the present thermal motor model.

11. The method as claimed in claim 7, wherein the process for generating a control signal is parameterized individually.

12. The method as claimed in claim 7, wherein at least one of a disconnection signal and warning signal is generated as a control signal.

13. The protective apparatus as claimed in claim 3, wherein the time value is dynamically calculatable using the present value for the thermal motor model.

14. The protective apparatus as claimed in claim 3, wherein at least one of the prediction device and the utilization device is parameterizable.

15. The protective apparatus as claimed in claim 3, wherein at least one of a disconnection signal and a warning signal are generatale as a control signal in the utilization device.

16. The method as claimed in claim 9, wherein the time value is calculated dynamically using the present thermal motor model.

17. The method as claimed in claim 8, wherein the process for generating a control signal is parameterized individually.

18. The method as claimed in claim 8, wherein at least one of a disconnection signal and warning signal is generated as a control signal.

19. The method as claimed in claim 9, wherein the process for generating a control signal is parameterized individually.

20. The method as claimed in claim 9, wherein at least one of a disconnection signal and warning signal is generated as a control signal.
